(19) United States
(12) Patent Application Publication
(10) Pub. No.: US 2006/0162206 A1
(43) Pub. Date: Jul. 27, 2006

(54) Exterior display sign apparatus

(76) Inventor: Stephen C. Pestillo, Southington, CT (US)

Correspondence Address: O'SHEA, GETZ & KOSAKOWSKI, P.C., 1500 MAIN ST., SUITE 912, SPRINGFIELD, MA, 01115, US

(21) Appl. No.: 11/335,929

(22) Filed: Jan. 20, 2006

Related U.S. Application Data
(60) Provisional application No. 60/646,366, filed on Jan. 24, 2005.

(51) Int. Cl. G09F 7/00

(52) U.S. Cl. 40/605

(57) ABSTRACT

An exterior display apparatus is provided that includes a plurality of individual signs and a frame. Each of the individual signs is operable to be displayed individually as a sign, and each has at least two mating elements. The mating elements from each individual sign mate with the mating elements of at least two adjacent individual signs. The individual signs thereby form a collective sign from the individual signs.

This application claims the benefit of and incorporates by reference essential subject matter disclosed in U.S. Provisional Patent Application No. 60/646,366 filed on Jan. 24, 2005.

### BACKGROUND OF THE INVENTION

1. Technical Field

The present invention relates to exterior display signs in general, and to exterior display signs that have multiple pieces that can be displayed separately in particular.

2. Background Information

Local governmental elections typically have a large number of candidates running for multiple offices. The candidates from a particular party form a slate that runs collectively against the candidates from a rival party.

A mechanism used to generate interest in the elections, a political party, and particular candidates is the road side sign. These signs are sometimes professionally printed using a particular format, and other times are hand made. In both cases, the individual signs do not lend themselves to advertising the slate as a whole. A large number of the individual signs are often posted in a particular area, leading to a maze of signs that cannot easily be read by the passing motorist. In some instances, large custom signs are used to display all of the candidates on a particular slate. Other than listing the candidates and possibly the political party, these large signs do little to convey the team concept of the party slate. Furthermore, the individual signs cannot be combined into the large signs, thereby limiting the manner in which they can be used.

What is needed is an exterior display sign that can be used in political party elections and the like, and one that illustrates the cohesive team character of the slate of candidates.

### DISCLOSURE OF THE INVENTION

An exterior display apparatus is provided that includes a plurality of individual signs and a frame. Each of the individual signs is operable to be displayed individually as a sign, and each has at least two mating elements. The mating elements from each individual sign mate with the mating elements of at least two adjacent individual signs. The individual signs thereby form a collective sign from the individual signs.

An advantage of the present exterior display apparatus is that it provides an exterior display apparatus that includes individual signs that can be displayed individually or collectively as a single collective sign. As individual signs, they can be “targeted” for maximum efficiency; e.g. Board of Education candidates displayed outside schools, etc. As a collective sign, they can be displayed at key locations (e.g., high traffic intersections) in a form that allows each individual sign to be easily seen and read.

Another advantage of the present exterior display apparatus is that each individual sign conveys the idea that it is part of a collective team. This is particularly true for those embodiments wherein the individual signs have interlocking elements that are jigsaw-puzzle shaped. The jigsaw-puzzle shape emphasizes the fact that the individual signs combine to make a larger display, which display implicitly or explicitly conveys the team. In some embodiments, elements that are not apparent from each individual sign become apparent when the individual signs are combined to form the collective sign; e.g. “Vote” as a message in the background, etc.

Another advantage of the present exterior display apparatus is that a professional looking exterior display is provided. The individual signs and collective sign project a desirable image that sets the candidates on display apart from those using presently available signage.

These and other objects, features and advantages of the present invention will become apparent in light of the detailed description of the invention provided below, and as illustrated in the accompanying drawings.

### BRIEF DESCRIPTION OF THE DRAWINGS

FIG. 1 is a view of an embodiment of the exterior display apparatus.

FIG. 2 is a view of an embodiment of the exterior display apparatus.

FIG. 3A is a view of an embodiment of an individual sign portion of the exterior display apparatus with mounting apparatus.

FIG. 3B is an exploded view of an embodiment of an individual sign portion of the exterior display apparatus with mounting apparatus.

FIG. 4 is a diagrammatic cross-sectional view showing individual signs disposed on opposite sides of a panel.

FIG. 5 is a diagrammatic view of an embodiment of the exterior display apparatus.

### DETAILED DESCRIPTION OF THE INVENTION

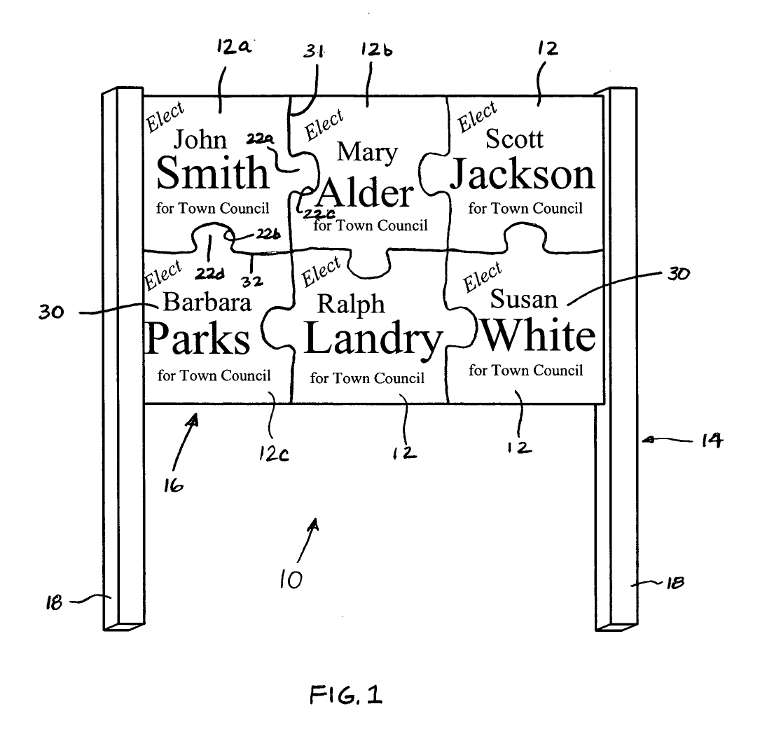

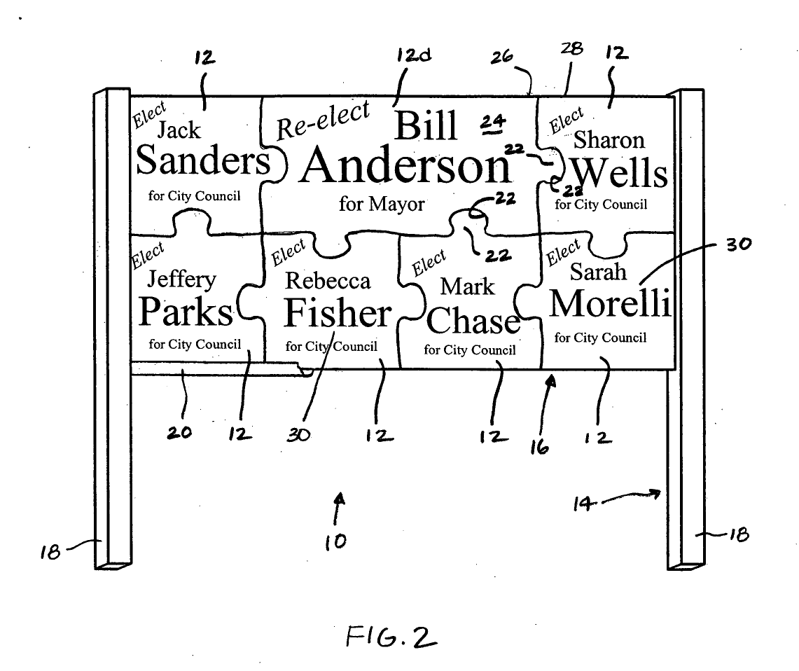

Referring to FIGS. 1 and 2, an exterior display apparatus 10 is provided that includes a plurality of individual signs 12 and a frame 14. Each of the individual signs 12 is operable to be displayed separately, and the individual signs 12 can be attached to one another to form a collective sign 16.

The frame 14 includes one or more legs 18 operable to support the collective sign 16 a distance from the ground. The frame 14 shown in FIGS. 1, 2 and 5 has a pair of legs 18. In some embodiments, the frame 14 may include one or more lateral supports 20 attached to the one or more legs 18. A portion or all of the lateral support(s) 20 may have a U-shape for receiving the collective sign 16 (see FIG. 2).

Each individual sign 12 includes one or more mating elements 22, a front face 24, a back face 26 (opposite the front face 24), and an edge surface 28. The individual signs 12 contain a display 30 (a design, text, etc.) on at least one of the front face 24 or back face 26. The mating elements 22 from each individual sign 12 mate with the mating elements 22 of at least one adjacent individual sign 12 in a manner wherein the mated mating elements 22 are visible within the collective sign 16. Using the embodiment shown in FIG. 1 as an example, a first individual sign 12a has a male mating element 22a that extends outwardly on a first side 31, and a female mating element 22b that extends outwardly on a second side 32. An adjacent second individual sign 12b has a female mating element 22c positioned and shaped to receive the male mating element 22a of the first individual sign 12a. A third individual sign 12c has a male mating element 22d positioned and shaped to be received within the female mating element 22b of the first individual sign 12a. The configuration of the mating elements 22 for each of the individual signs 12 depends upon their position in the collective sign 16.

In a preferred embodiment, the male and female mating elements 22 are shaped so that each individual sign 12 appears as a jigsaw-puzzle shaped piece. The collective sign 16, therefore, appears to be a jigsaw puzzle.

While one or more of the individual signs 12 in a collective sign 16 may have the same shape, the shapes of all of the individual signs 12 are preferably not uniform. The collective sign 16 shown in FIG. 1, for example, has at least three differently shaped individual signs 12.

In some embodiments of the exterior display apparatus 10, the face surface areas of each individual sign 12 are approximately equal to the face surface areas of the other individual signs 12. In other embodiments (as shown in FIG. 2), the face surface area of at least one of the individual signs 12d is substantially larger than that of the others. The larger face surface area can, for example, draw additional attention to the display contained on that individual sign 12d. For example, the larger individual sign 12d may be used to advertise the candidate for the mayor or chairman position of the town council as opposed to the other town council positions up for election.

The individual signs 12 may be formed from a variety of different materials. Polymer materials are particularly useful because of their durability in inclement weather. In some embodiments, the individual signs 12 are made from corrugated plastic which provides desirable stiffness, lightweight, and durability, and which is easily handled during the manufacturing process.

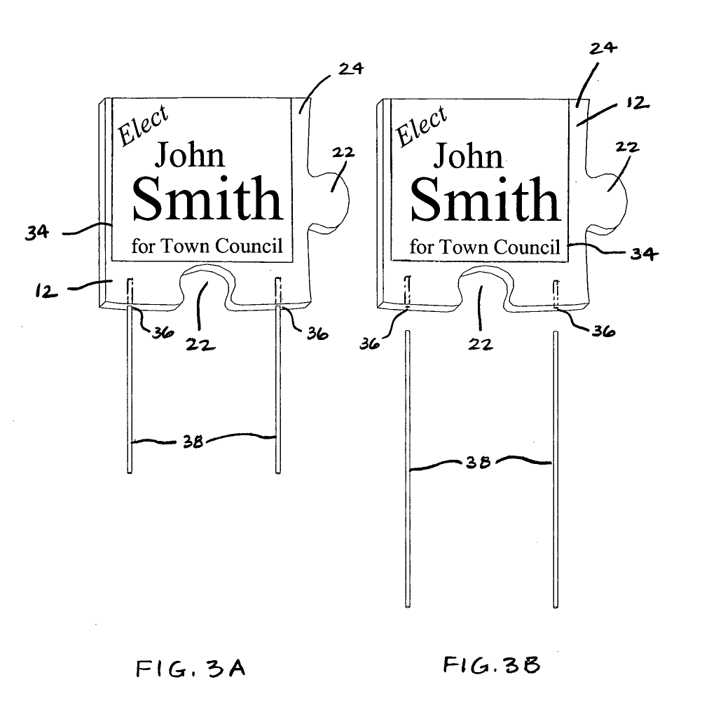

Now referring to FIGS. 1, 3A, and 3B, in some embodiments the display contained on at least one of the front face 24 or back face 26 is deposited directly on the individual sign 12 (e.g., see FIG. 1). In other embodiments, the display may be attached (e.g., printing, etc.) to a graphic medium 34 that is attachable to the individual sign 12 by adhesive, mechanical means, etc. (see FIGS. 3A and 3B) The use of a graphic medium 34 facilitates using the individual sign 12 more than once.

Each individual sign 12 preferably includes mounting apparatus that enables the individual sign 12 to be mounted on a stand. For example, in some embodiments each individual sign 12 includes one or more apertures 36 disposed in the edge surface 28 (see FIGS. 3A and 3B) that are sized to receive rods 38 that enable the individual sign 12 to be mounted relative to the ground. In those embodiments that utilize corrugated plastic, the apertures 36 may be found within the corrugations.

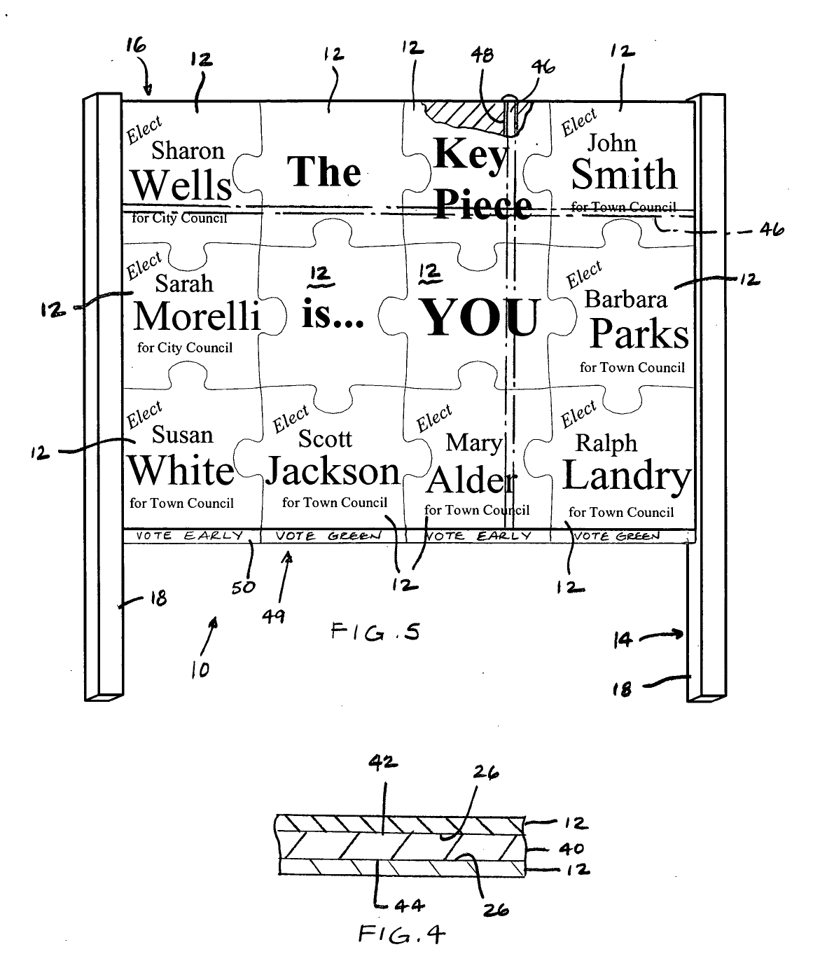

Referring to FIG. 4, in some embodiments the exterior display apparatus 10 includes a panel 40 that is placed against the back faces 26 of the individual signs 12 to support the individual signs 12. The panel 40 has a first side 42 and a second side 44. If the first side 42 is placed contiguous with the back faces 26 of the individual signs 12, and nothing is placed on the second side 44 of the panel 40, then the collective sign 16 will likely have a display only shown on one surface. In some embodiments, individual signs 12 are disposed on the second side 44 of the panel 40 as well as the first side 42. Consequently, the collective sign 16 has displays shown on two surfaces. The individual signs 12 may be supported by the panel 40 in any number of different ways (e.g., mechanical fasteners, adhesives, etc.) and the present exterior sign apparatus 10 is not limited to any particular support mechanism with respect to the panel 40.

Now referring to FIG. 5, in some embodiments the present exterior sign apparatus 10 includes locking members 46 (shown in phantom in part) that engage adjacent individual signs 12 to prevent the adjacent individual signs 12 from separating from one another; e.g., locking members 46 that keep adjacent individual signs 12 substantially in the same plane. The embodiment shown in FIG. 5 includes locking members 46 that extend through apertures 48 within the individual signs 12. The locking members 46 impede or prevent separation of adjacent individual signs 12; e.g., relative movement of adjacent individual signs 12 into or out of the plane of the page. The present exterior sign apparatus 10 is not limited to the aforesaid example of locking members 46.

In some embodiments, the individual signs 12 include portions of a graphic display 49 (e.g., a message or an image) that is shown in its entirety in the collective sign 16. For example, a word (e.g., “VOTE”) or an image (e.g., a geographic outline of the town) may be included in gray scale sized to take up substantially the entire collective sign 16. Each individual sign 12 contains a portion of the gray scale that forms the collective graphic display, but no individual sign 12 contains the graphic display in its entirety. In another example, each individual sign 12 may have a border region 50 that has a portion or all of a message (e.g., “VOTE GREEN”; see FIG. 5). When the individual signs 12 are combined into the collective sign 16, then the border message across the entire length (or periphery) of the collective sign 16 becomes apparent.

In some embodiments, the individual signs 12 are each substantially a solid color and at least one of the individual signs 12 is a first color (e.g., blue), and at least another of the individual signs 12 is a second color (e.g., white) which is not the same as the first color. The colors can be used to draw attention to certain of the individual signs 12, and to the collective sign 16 as a whole.

Although this invention has been shown and described with respect to the detailed embodiments thereof, it will be understood by those skilled in the art that various changes in form and detail thereof may be made without departing from the spirit and the scope of the invention.

What is claimed is:

1. An exterior display apparatus, comprising:
a plurality of individual signs, each operable to be displayed individually as a sign, and each having at least two mating elements, wherein the mating elements from each individual sign mate with the mating elements of at least two adjacent individual signs, thereby forming a collective sign from the individual signs; and
a frame operable to support the collective sign.

2. The apparatus of claim 1, wherein the interlocking elements are mating male and female jigsaw-puzzle shaped elements.

3. The apparatus of claim 2, wherein the individual signs are each substantially a solid color, and at least one of the individual signs is a first color, and at least another of the individual signs is a second color which is not the same as the first color.

4. The apparatus of claim 1, wherein the frame comprises at least one leg operable to support the collective sign relative to the ground.

5. The apparatus of claim 4, wherein the frame further comprises at least one lateral support attached to the at least one leg.

6. The apparatus of claim 4, wherein the frame includes a pair of legs and the collective sign is disposed between the pair of legs.

7. The apparatus of claim 6, wherein the frame further comprises at least one lateral support attached to and extending between the legs.

8. The apparatus of claim 1, wherein each of the individual signs has a geometric shape, and the geometric shapes of the individual signs are non-uniform.

9. The apparatus of claim 1, wherein each of the individual signs has a face surface area, and the face surface area of the each individual sign is approximately equal to the face surface area of the other individual signs.

10. The apparatus of claim 1, wherein each of the individual signs has a face surface area, and at least one of the individual signs has a face surface area that is substantially larger than the face surface area of the other individual signs.

11. The apparatus of claim 1, wherein each individual sign 12 comprises mounting apparatus.

12. The apparatus of claim 11, wherein the mounting apparatus includes at least one apertures disposed in an edge surface 28 of the individual sign sized to receive a rod.

13. The apparatus of claim 1, further comprising a panel disposed contiguous with the individual signs, the panel having a first side and a second side.

14. The apparatus of claim 13, wherein individual signs are disposed contiguous with the first side and the second side.

15. The apparatus of claim 1, further comprising one or more locking members that engage adjacent individual signs, which locking members are operable to inhibit adjacent individual signs from separating from one another.

16. The apparatus of claim 1, wherein the individual signs include portions of a graphic display that is shown in its entirety in the collective sign.
